(19) United States
(12) Patent Application Publication
(10) Pub. No.: US 2025/0008939 A1
(43) Pub. Date: Jan. 9, 2025

(54) IRRADIATION DEVICE AND IRRADIATION METHOD

(71) Applicant: OSAKA UNIVERSITY, Osaka (JP)

(72) Inventors: Hiroshi FUJI, Osaka (JP); Kazuhisa YAMAMOTO, Osaka (JP)

(21) Appl. No.: 18/710,932

(22) PCT Filed: Sep. 21, 2022
(86) PCT No.: PCT/JP2022/035084

§ 371 Date: May 16, 2024

(30) Foreign Application Priority Data
Nov. 17, 2021 (JP) 2021-187356

(51) Int. Cl. A01M 1/22; G06T 7/73

(52) U.S. Cl. CPC A01M 1/226; G06T 7/73; G06T 2207/10028

(57) ABSTRACT

Provided is an irradiation device that is capable of effectively suppressing activities of insect pests. An irradiation device (100) includes: a detection section (31) that detects an insect which is an irradiation target; an identification section (32) that identifies position information of the irradiation target; and an irradiation section (1) that, based on the position information, irradiates the irradiation target with shooting laser light (L2) while targeting a specific part of the irradiation target.

### TECHNICAL FIELD

The present invention relates to an irradiation device and an irradiation method for irradiating an insect pest with laser light.

### BACKGROUND ART

In recent years, loss of crops due to insect pests has been a social problem. As a means of controlling insect pests, for example, insecticides have mainly been used. However, the costs of the development of insecticides are high, and the use of insecticides brings about an issue of insect pests developing resistance. Under the circumstances, there are demands for a technique for controlling insect pests by, instead of such insecticides, a physical method using laser light.

For example, Patent Literature 1 discloses a device for disease and pest control, chemical weed control, and sterilization, which uses a rotation mirror to converge laser light that has been non-collimated by a lens system onto an irradiation target so as to irradiate the irradiation target. Non Patent Literature 1 discloses a technique for using the wingbeat frequency of an insect detected by reflected light of laser light to recognize the type of the insect and irradiating, with laser light, the insect which is an irradiation target.

### CITATION LIST

### Patent Literature

### Patent Literature 1

Japanese Patent Application Publication, Tokukai, No. 2001-275541

### Non-Patent Literature

### Non-patent Literature 1

Emma R. Mullen, Phillip Rutschman, Nathan Pegram, Joseph M. Patt, John J. Adamczyk Jr., and 3ric Johanson, “Laser system for identification, tracking, and control of flying insects”, OPTICS EXPRESS, May 30, 2006, Vol. 24, No. 11, P. 11828-11838

### SUMMARY OF INVENTION

### Technical Problem

However, in the above techniques, irradiating insect pests having a relatively large entire length (such as Spodoptera litura having an entire length of 20 mm to 30 mm) with laser light is not taken into consideration. Therefore, there is unfortunately a possibility that irradiating an insect pest having a relatively large entire length with laser light having a beam spot diameter of several millimeters may not be effective depending on the part to be irradiated with the laser light.

An aspect of the present invention has been made in view of the above problem, and an object thereof is to provide an irradiation device that is capable of effectively suppressing activities of insect pests.

### Solution to Problem

In order to attain the object, an irradiation device in accordance with an aspect of the present invention includes: a detection section that detects an insect which is an irradiation target; an identification section that identifies position information of the irradiation target; and an irradiation section that, based on the position information, irradiates the irradiation target with shooting laser light while targeting a specific part of the irradiation target.

In order to attain the object, an irradiation method in accordance with an aspect of the present invention includes the steps of: detecting an insect which is an irradiation target; identifying position information of the irradiation target; and irradiating, based on the position information, the irradiation target with shooting laser light while targeting a specific part of the irradiation target.

### Advantageous Effects of Invention

With an aspect of the present invention, it is possible to effectively suppress activities of insect pests.

### BRIEF DESCRIPTION OF DRAWINGS

FIG. 1 is a block diagram illustrating a configuration of an irradiation device in accordance with an embodiment of the present invention.

FIG. 2 is a view illustrating parts of an insect which is an irradiation target of the irradiation device.

FIG. 3 is a view showing that an insect is irradiated, from the lateral side of the insect, with shooting laser light from the irradiation device.

FIG. 4 is a view showing that an insect is irradiated, from above the insect, with shooting laser light from the irradiation device.

FIG. 5 is a view showing that an insect is irradiated, from below the insect, with shooting laser light from the irradiation device.

FIG. 6 is a flowchart showing an example of a flow of a process of the irradiation device.

FIG. 7 is a block diagram illustrating a configuration of an irradiation device in accordance with another embodiment of the present invention.

FIG. 8 is a view showing reactions of insects when each part of the insects was irradiated with laser light.

### DESCRIPTION OF EMBODIMENTS

### Embodiment 1

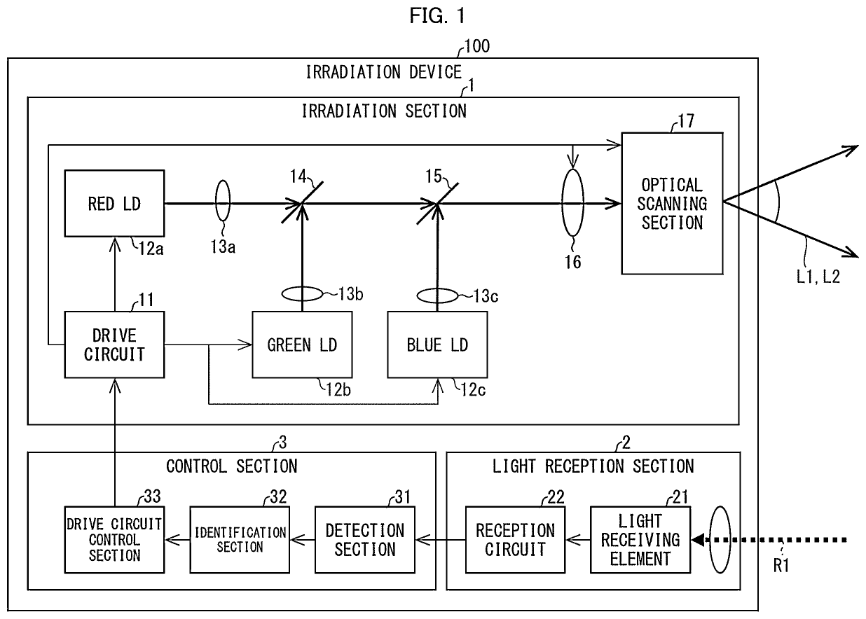

FIG. 1 is a block diagram illustrating a configuration of an irradiation device 100 in accordance with Embodiment 1. As illustrated in FIG. 1, the irradiation device 100 includes an irradiation section 1, a light reception section 2, and a control section 3. The irradiation device 100 detects an insect (insect pest) which is an irradiation target, and irradiates the insect pest with laser light while targeting a specific part. In the present embodiment, the irradiation target refers to a large insect pest having an entire length of 20 mm to 60 mm, such as Spodoptera litura, Heliothis armigera, Schistocerca gregaria, and Oxya. An insect pest refers to an insect that causes harm to production activities or daily living of humans. Even the same insect may be an insect pest or a beneficial insect, depending on the case. Therefore, examples of the irradiation target include not only insects that cause harm to agricultural production but also insects that cause harm in daily living, such as Vespinae and Cerambycidae. The irradiation device 100 can be provided on a movable robot such as a drone or a mobile robot. Alternatively, the irradiation device 100 can be secured so as to be able to shoot an insect pest within a predetermined range.

The irradiation section 1 includes a drive circuit 11, light emitting elements 12a through 12c (red (laser diode) LD 12a, a green LD 12b, and a blue LD 12c), collimating lenses 13a through 13c, half mirrors 14 and 15, a variable focus lens 16, and an optical scanning section 17. The irradiation section 1 irradiates a predetermined range (irradiation space) with scanning laser light L1 and scans the irradiation space at predetermined intervals. The irradiation space is, for example, a space that extends from the laser light emission section (optical scanning section 17) to a point which is several tens of meters away, in a predetermined field of view (solid angle). Based on position information identified by an identification section 32 described later, the irradiation section 1 emits shooting laser light L2 while targeting a specific part of the irradiation target. It should be noted that the shooting laser light L2 is pulse light having a pulse width of 0.01 seconds to 0.2 seconds. The shooting laser light L2 is typically emitted upwards from below an irradiation target that is flying.

The drive circuit 11 is controlled by a drive circuit control section 33 described later so as to drive the light emitting elements 12a through 12c, the variable focus lens 16, and/or the optical scanning section 17. Specifically, the drive circuit 11 applies a drive current to at least one selected from the group consisting of the light emitting elements 12a through 12c so as to cause emission of laser light. The drive circuit 11 also applies a drive voltage to the variable focus lens 16 so as to adjust the focal length of the laser light. The drive circuit 11 also applies a drive voltage to the optical scanning section 17 so as to adjust the emission angle of the laser light.

For example, when the irradiation device 100 scans the irradiation space, the drive circuit 11 applies a drive current to each of the light emitting elements 12a through 12c so as to cause emission of scanning laser light L1 having a power density of approximately 0.01 mW/mm² through 100 mW/mm². The drive circuit 11 also applies a drive voltage to the variable focus lens 16 so as to put the focal point in distance (that is, the beams of the laser light become substantially parallel). The drive circuit 11 also applies a drive voltage to the optical scanning section 17 so that the emission angle of the scanning laser light L1 changes with time, so as to scan the irradiation space. Hereinafter, the mode in which the drive circuit 11 performs the above operation when the irradiation device 100 scans an irradiation space will be referred to as “scanning mode”.

When the irradiation device 100 shoots an irradiation target, the drive circuit 11 applies a drive current to the blue LD 12c so as to cause emission of shooting laser light L2 having a power density of approximately 0.1 W/mm² to 10 W/mm² which is greater than that during the scanning. The drive circuit 11 also applies a drive voltage to the variable focus lens 16 so as to align the focal point of the shooting laser light L2 with a specific part of the irradiation target. It should be noted that the beam spot diameter of laser light only needs to be 1 mm to 10 mm. The drive circuit 11 also applies a drive voltage to the optical scanning section 17 to adjust the emission angle (emission direction) of the shooting laser light L2 so that the shooting laser light L2 irradiates the specific part of the irradiation target. Hereinafter, the mode in which the drive circuit 11 performs the above operation when the irradiation device 100 shoots the irradiation target will be referred to as “shooting mode”. It should also be noted that although the blue LD 12c, which emits blue light that is effectively absorbed by an irradiation target, is used as a light source for the shooting laser light L2, the present invention is not limited to this configuration. Alternatively, a light source of another color can be used.

The light emitting elements 12a through 12c are light sources that each generate laser light. For example, the light emitting elements 12a through 12c are a red LD 12a, a green LD 12b, and a blue LD 12c that irradiate laser light of red color, green color, and blue color, respectively. The light emitting elements 12a through 12c each emit a laser light having an intensity that corresponds to a drive current (or a drive voltage) applied by the drive circuit 11.

The collimating lenses 13a through 13c are lenses that collimate the beams of laser light emitted from the light emitting elements 12a through 12c, respectively. The half mirrors 14 and 15 are multiplexers that synthesize beams of laser light of the respective colors from the collimating lenses 13a through 13c. The synthesized laser light passes through the variable focus lens 16 and are then supplied to the optical scanning section 17.

The variable focus lens 16 is an optical element that is for changing the focal points of the beams of laser light. The variable focus lens 16 non-collimates the parallel beams of laser light from the half mirrors 14 and 15. For example, the variable focus lens 16 includes a liquid lens. The shape of a lens surface of the liquid lens changes in response to a drive voltage. This makes it possible to change the focal length. The variable focus lens 16 can also include a liquid crystal lens. The refractive index of liquid crystals of the liquid crystal lens changes in response to a drive voltage. This makes it possible to change the focal length. With such a variable focus lens 16, it is possible to rapidly switch the focal points of the beams of laser lights by applying a drive voltage. The variable focus lens 16 can include a movable lens that moves in the optical axis direction. When a distant irradiation target is to be irradiated, the focal lengths become long and the beams of laser light become substantially parallel (are close to being parallel).

The optical scanning section 17 is an optical element that is for adjusting the emission angle of the laser light. The optical scanning section 17 changes the optical path of the laser light from the variable focus lens 16, and emits the laser light from the irradiation section 1 with a desired emission angle with respect to the optical axis of the incident light. For example, optical scanning section 17 includes a movable mirror such as a galvanometer mirror. The rotation angle of the movable mirror changes in response to a drive voltage applied by the drive circuit 11. The optical scanning section 17 can be a micro-electro-mechanical systems (MEMS) mirror.

The light reception section 2 includes a light receiving element 21 and a reception circuit 22. The light reception section 2 receives reflected light R1 of scanning laser light L1, and generates a light reception signal (a three-dimensional image of a detection target and color information of the detection target) that allows a detection section 31 (described later) to detect an irradiation target. The light reception section 2 is a distance measurement sensor, such as light detection and ranging (LiDAR), using a time-of-flight (TOF) method. That is, the light reception section 2 receives reflected light R1 which is of the scanning laser light L1 emitted from the irradiation section 1 and which has been reflected by the detection target that exists in the irradiation space. The scanning laser light L1 is intensity-modulated light in the form of, for example, pulses or sine waves, and the modulation is performed by the drive circuit 11. This allows the light reception section 2 to detect a time of flight of the laser light based on a time delay (or phase delay) in intensity change of the scanning light (scanning laser light L1), and measures the distance from the irradiation device 100 to the detection target. The light reception section 2 also receives the reflected light R1 of scanning laser light L1 of each color, so as to obtain color information of the detection target in the irradiation space. It should be noted that the scope of the detection target includes not only insect pests which are irradiation targets but also beneficial insects (such as Apis mellifera) and leafs of trees on which insect pests are resting.

The light receiving element 21 receives the reflected light R1 which has been reflected by the detection target, and converts the reflected light R1 into an electric signal. The light receiving element 21 outputs the electric signal to the reception circuit 22. The light receiving element 21 is, for example, a charge coupled device (CCD), a complementary metal-oxide semiconductor (CMOS), or a photodiode. The light receiving element 21 can be, for example, a light receiving element array in which light receiving elements that correspond to predetermined partial spaces in the irradiation space (i.e., that receive reflected light R1 of the scanning laser light L1 with which the predetermined partial space has been irradiated) are provided in an array. In addition, the light receiving element 21 can have light receiving elements (RGB pixels) that receive the laser light of respective colors.

When the reception circuit 22 has received the electric signal indicating that the reflected light R1 has been received from the light receiving element 21, the reception circuit 22 detects, as a time delay (or phase delay) in intensity change, a time of flight of the laser light from the time at which the irradiation section 1 emitted the scanning laser light L1 to the time at which the light receiving element 21 received the reflected light R1. This allows the reception circuit 22 to measure the distance from the irradiation device 100 to the detection target. Furthermore, based on the emission angle of the scanning laser light L1 and on the distance from the irradiation device 100 to the detection target, the reception circuit 22 generates a three-dimensional image (three-dimensional position information) of the detection target. The reception circuit 22 also generates color information of the detection target on the basis of the electric signal indicating that the reflected light R1 of the scanning laser light L1 of each color has been received. It should be noted that the reception circuit 22 updates the three-dimensional image of the detection target and the color information of the detection target at predetermined intervals (frame rate) at which the scanning laser light L1 is emitted.

The control section 3 includes the detection section 31, the identification section 32, and the drive circuit control section 33. The control section 3 performs overall control of the sections of the irradiation device 100.

The detection section 31 detects an insect which is an irradiation target. Specifically, the detection section 31, from the reception circuit 22, obtains the three-dimensional image of the detection target and the color information of the detection target or obtains the flight trajectory of the detection target. Based on the three-dimensional image of the detection target and the color information of the detection target or on the flight trajectory pattern, the detection section 31 determines whether or not the detection target is an insect (insect pest) which is an irradiation target. When the detection target is an insect which is an irradiation target, the detection section 31 transmits the three-dimensional image of the detection target (irradiation target) to the identification section 32.

The identification section 32 decides a specific part of the irradiation target. Specifically, the identification section 32 obtains the three-dimensional image of the irradiation target from the detection section 31. Based on the three-dimensional image of the irradiation target, the identification section 32 identifies, from among the parts of the irradiation target, parts that can be irradiated with shooting laser light L2. According to the irradiation target, the identification section 32 decides, from among the parts that can be irradiated with the shooting laser light L2, a specific part that can be irradiated with laser light so as to damage the irradiation target.

The identification section 32 also identifies position information of the irradiation target. Specifically, the identification section 32 obtains the three-dimensional image of the irradiation target at predetermined intervals, so as to predict the trajectory of the irradiation target. For example, when the irradiation target is flying, the identification section 32 predicts future three-dimensional position information of the irradiation target in view of the flight pattern of the irradiation target. This allows the identification section 32 to identify the position information of the irradiation target which includes the position of the specific part at the time at which the irradiation section 1 emits laser light.

When the drive circuit control section 33 has received the position information of the irradiation target from the identification section 32, the drive circuit control section 33 outputs, to the drive circuit 11, an instruction for switching from the scanning mode to the shooting mode. In this case, the drive circuit control section 33 controls the drive voltage of the drive circuit 11 so that the focal length of the variable focus lens 16 and the emission angle of the laser light are based on the position information of the irradiation target.

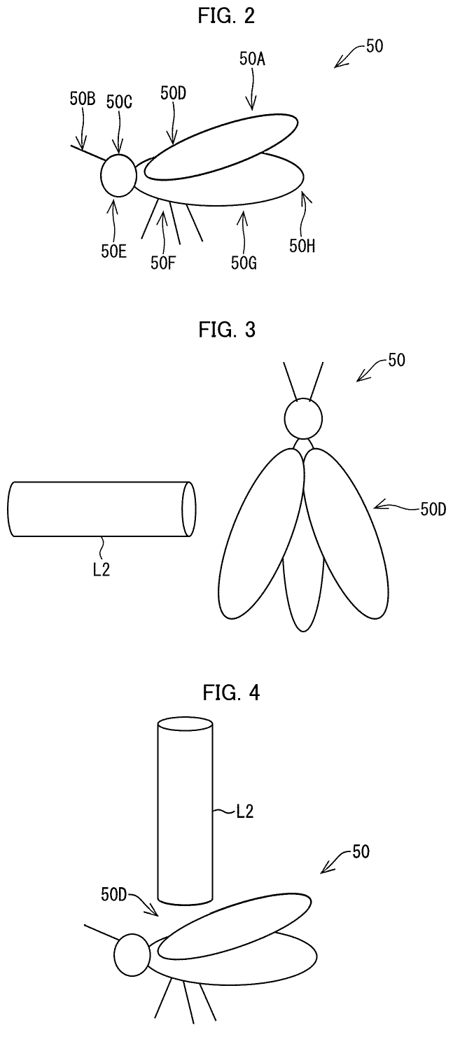

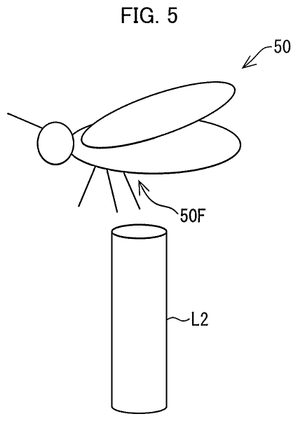

FIG. 2 is a view illustrating the parts of an irradiation target 50 (insect pest) of an irradiation device 100. FIG. 3 is a view showing that the irradiation target 50 is irradiated, from the lateral side of the irradiation target 50, with shooting laser light L2 from the irradiation device 100. FIG. 4 is a view showing that the irradiation target 50 is irradiated, from above the irradiation target 50, with shooting laser light L2 from the irradiation device 100. FIG. 5 is a view showing that the irradiation target 50 is irradiated, from below the irradiation target 50, with shooting laser light L2 from the irradiation device 100. As illustrated in FIG. 2, an insect can be divided into a plurality of parts. In the example shown in FIG. 2, the irradiation target 50 is divided the following eight parts: wings 50A, an antennae 50B, a head 50C, a back 50D, a face 50E, a thorax 50F, an abdomen 50G, and an ovipositor 50H.

It should be noted that wings 50A are a wing part of the insect. When the insect is not flying, the wings 50A may cover the side opposite from the side on which the legs at the abdominal part are positioned. The head 50C is a part on the side (back side) opposite from the side on which the mouth at the head part of the insect is positioned. The back 50D is a part on the side opposite from the side on which the legs at the thoracic part of the insect are positioned. The face 50E is a part on the side on which the mouth at the head part of the insect is positioned. The thorax 50F is a part on the side on which the legs at the thoracic part of the insect are positioned. The abdomen 50G is a part on the side on which the legs at the abdominal part of the insect are positioned. The ovipositor 50H is a part at which the reproductive organ of the insect is positioned.

Examples of the specific part where damage (injury) to the irradiation target 50 can be caused effectively include: the thorax 50F at which the base of the legs for movements is positioned; the face 50E at which the mouth for feeding is positioned; and the ovipositor 50H at which the reproductive organ is positioned. These specific parts are positioned at the lower side of the irradiation target 50 that is flying. Therefore, the irradiation device 100 can target the specific part of the irradiation target 50 and irradiate the irradiation target 50 with shooting laser light L2 by irradiating the flying irradiation target 50 upwards with the shooting laser light L2 from below.

As illustrated in FIGS. 3 through 5, the shooting laser light L2 from the irradiation device 100 irradiates the specific part of the irradiation target 50. In the example shown in FIG. 3, the shooting laser light L2 irradiates the wings 50A, the back 50D, or the thorax 50F of the irradiation target 50 from the lateral side. In the examples shown in FIGS. 3 and 4, the shooting laser light L2 irradiates the back 50D of the irradiation target 50. In the example shown in FIG. 5, the shooting laser light L2 irradiates the thorax 50F of the irradiation target 50. That is, the irradiation section 1 does not irradiate the entire irradiation target 50 with shooting laser light L2, but irradiates the irradiation target 50 with shooting laser light L2 that has a beam diameter (1 mm to 10 mm) which is smaller, at the position of the irradiation target, than the entire length (20 mm to 60 mm) of the irradiation target 50. This makes it possible to increase the power density of pulse light having predetermined energy, in comparison with a case where the entire irradiation target 50 is irradiated with shooting laser light L2. Irradiating the predetermined part of the irradiation target 50 with such laser light can more reliably cause damage to the irradiation target 50.

The ratio of the beam diameter to the entire length of the irradiation target 50 can be, for example, ½ or less, or ⅓ or less. A smaller ratio of the beam diameter to the entire length of the irradiation target 50 makes it possible to concentrate energy more on an effective part, and therefore makes it possible to cause damage to the irradiation target 50 with laser light having less energy. The length of the thoracic part or the head part of an insect is ½ or less of the entire length of the insect. In many cases, the length of the thoracic part or the head part of an insect is ⅓ or less. Therefore, in many cases, the length of each part (particularly of the thorax 50F or the face 50E) of the irradiation target 50 in FIG. 2 is ⅓ or less of the entire length of the irradiation target 50. For example, when the irradiation target 50 is an insect pest having an entire length of 20 mm, a beam diameter of 6 mm or less makes it possible to irradiate only the thorax 50F. In addition, the beam diameter can be set to 3 mm or less when the irradiation target 50 is an insect pest having an entire length of 20 mm or less, for example, an insect pest having an entire length of 10 mm. Thus, irradiating the irradiation target 50 with laser light having a beam diameter of ⅓ or less of the entire length of the irradiation target 50 makes it possible to irradiate only an effective part with the laser light. It is therefore possible to cause damage to the irradiation target 50 with laser light having less energy.

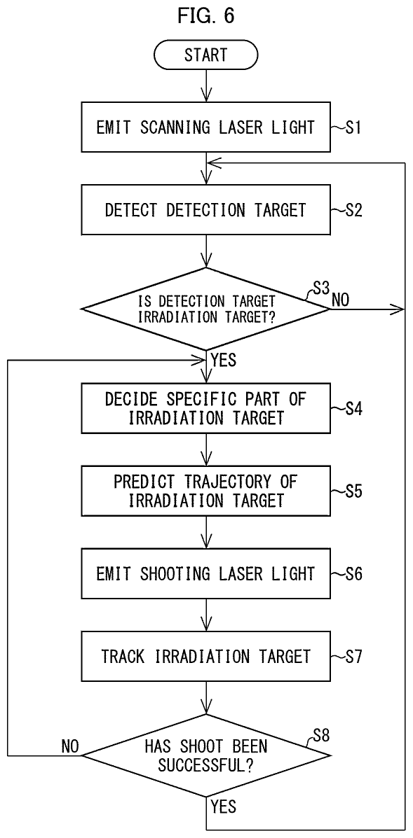

FIG. 6 is a flowchart showing an example of a flow of the process of the irradiation device 100. With reference to FIG. 6, an example of an operation in which the irradiation device 100 detects an irradiation target and irradiates the irradiation target with laser light while targeting a specific part will be described below.

As illustrated in FIG. 6, the drive circuit control section 33 first causes the drive circuit 11 to enter the scanning mode. This causes the irradiation section 1 to irradiate an irradiation space with scanning laser light L1 and scans the irradiation space at predetermined intervals (S1).

Next, the light reception section 2 receives reflected light R1 of the scanning laser light L1 and detects a detection target within the irradiation space (S2). The light reception section 2 also generates a three-dimensional image of the detection target and color information of the detection target.

Next, based on the three-dimensional image of the detection target and the color information of the detection target, the detection section 31 determines whether or not the detection target is an irradiation target (detection step S3). If the detection target is an irradiation target (YES in S3), the process proceeds to S4. If the detection target is not an irradiation target (NO in S3), the process returns to S2. That is, the irradiation device 100 performs scanning of the irradiation space until an irradiation target is detected.

Next, based on the three-dimensional image of the irradiation target, the identification section 32 decides a specific part that can be irradiated with laser light so as to damage the irradiation target (S4). The identification section 32 also obtains a three-dimensional image of the irradiation target at predetermined intervals. This allows the identification section 32 to predict the trajectory of the irradiation target. That is, the identification section 32 identifies position information of the irradiation target which includes the position of the specific part at the time at which the irradiation section 1 emits laser light (identification step S5). It should be noted that if the identification section 32 determines that the irradiation target is being still, S5 can be omitted. In this case, the identification section 32 identifies position information of the irradiation target which includes the position of the specific part in the three-dimensional image of the irradiation target. It should be noted that the identification section 32 can decide a different specific part, according to the type of the irradiation target (type of the insect pest). This is because an effective shooting part differs, depending on the irradiation target.

Next, when the drive circuit control section 33 has received the position information of the irradiation target from the identification section 32, the drive circuit control section 33 outputs, to the drive circuit 11, an instruction for switching from the scanning mode to the shooting mode. This causes the irradiation section 1 to, based on the position information of the irradiation target, emits shooting laser light L2 while targeting the specific part of the irradiation target (irradiation step S6).

Next, the drive circuit control section 33 outputs, to the drive circuit 11, an instruction for switching from the shooting mode to the scanning mode. This tracks the irradiation target after the shooting (S7). That is, the light reception section 2 detects reflected light R1 of the scanning laser light L1 which has been reflected from the irradiation target, and generates a three-dimensional image of the irradiation target. Next, based on the three-dimensional image of the irradiation target, the identification section 32 determines whether or not the shooting was successful (that is, whether or not effective damage was made to the irradiation target) (S8). For example, when the irradiation target exhibits an action that differs from an ordinary action, such as falling or writhing, the identification section 32 determines that the shooting was successful. If the shooting was successful (YES in S8), the process returns to S2, and the scanning of the irradiation space is continued. If the shooting was unsuccessful (NO in S8), the process returns to S4, and the shooting of the irradiation target is continued.

With such a configuration, even in a case of an insect pest having a relatively large entire length, targeting a specific part of the insect pest and irradiating the insect pest with laser light can cause damage to the insect pest more effectively than with the conventional techniques. In addition, targeting and irradiating the thorax 50F, the face 50E, or the ovipositor 50H as a specific part with laser light can cause damage to an insect pest more effectively.

In addition, the irradiation section 1 does not irradiate the entire irradiation target 50 with shooting laser light L2, but irradiates the irradiation target 50 with shooting laser light L2 that has a beam diameter which is smaller, at the positon of the irradiation target, than the entire length of the irradiation target 50. This makes it possible to increase the energy density of laser light having predetermined energy, in comparison with a case where the entire irradiation target 50 is irradiated with shooting laser light L2. Irradiating the specific part of the irradiation target 50 with such laser light can more effectively cause damage to the irradiation target 50.

In addition, based not only on the three-dimensional image of the detection target but also on the color information of the detection target obtained by receiving the laser light of each color, the detection section 31 determines whether or not the detection target is an insect pest. This makes it possible to more accurately identify whether or not the detection target is an insect pest. In addition, since the irradiation device 100 detects an insect pest by scanning laser light, it is possible even at night to determine whether or not the detection target is an insect pest.

### Embodiment 2

The following description will discuss another embodiment of the present invention. Note that, for convenience of description, members having functions identical to those described in the aforementioned embodiment are assigned identical referential numerals, and their descriptions are not repeated.

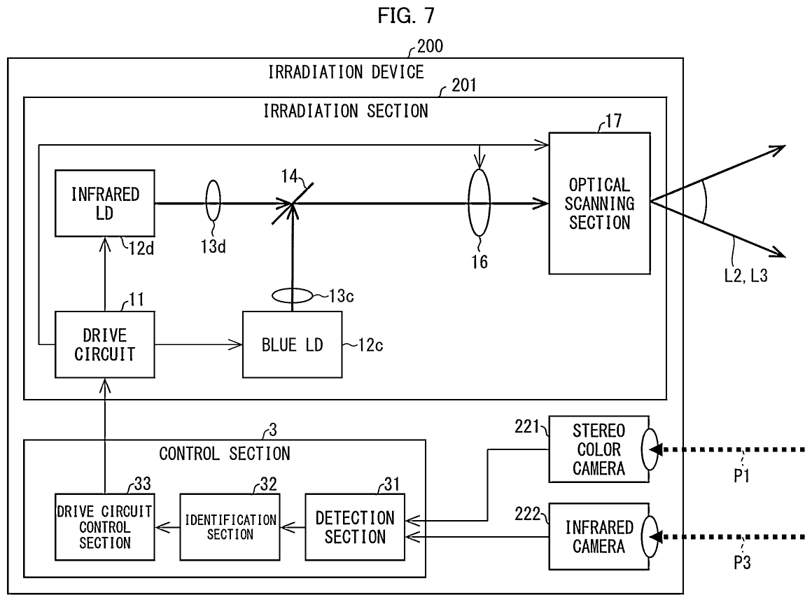

FIG. 7 is a block diagram illustrating a configuration of an irradiation device 200 in accordance with Embodiment 2. An irradiation device 200 differs from the irradiation device 100 in that the irradiation device 200 includes an irradiation section 201 instead of the irradiation section 1. The irradiation device 200 differs from the irradiation device 100 in that the irradiation device 200 includes, instead of the light reception section 2, stereo color cameras 221 (first image capturing section) and an infrared camera 222 (second image capturing section).

The irradiation section 201 differs from the irradiation section 1 in that the irradiation section 201 includes an infrared LD 12d and a collimating lens 13d instead of the red LD 12a, the green LD 12b, and the collimating lens 13a and 13b.

In Embodiment 1, the irradiation section 1 emits scanning laser light L1, and the light reception section 2 receives reflected light R1 of the scanning laser light L1. In Embodiment 2, the irradiation section 201 does not emit scanning laser light L1, and the stereo color cameras 221 capture image data P1 of a predetermined range. Specifically, two or more stereo color cameras 221 are used to obtain image data P1 that includes three-dimensional image of a detection target and color information of the detection target (that allows the detection section 31 to recognize an irradiation target). The image data P1 obtained by the stereo color cameras 221 is transmitted to a detection section 31. It should be noted that the stereo color cameras 221 can obtain image data P1 at predetermined intervals. The stereo color cameras 221 can include a white light source (lighting) so as to be able to capture images at night. In addition, instead of the stereo color cameras 221 as a first image capturing section, it is possible to use stereo infrared cameras for receiving infrared light and obtaining an infrared image. In this case, the stereo infrared cameras obtain, from the infrared image of the detection target, information (three-dimensional image) pertaining to shape and size. This allows the first image capturing section to capture images at night. Alternatively, the stereo color cameras 221 can also serve the function of the infrared camera 222 described later.

Before emitting shooting laser light L2, the irradiation section 201, based on position information identified by an identification section 32, emits aiming laser light L3 which is for aligning the aim with the irradiation target and then emits laser light while targeting a specific part of the irradiation target. Specifically, when the drive circuit control section 33 has received the position information of the irradiation target based on the image data P1 obtained by the stereo color cameras 221, the drive circuit control section 33 outputs, to a drive circuit 11, an instruction for starting an aiming mode. In the aiming mode, the drive circuit 11 applies a drive current to the infrared LD 12d so as to cause emission of aiming laser light L3 having a power density of approximately 0.01 mW/mm² through 100 mW/mm². The drive circuit 11 also applies a drive voltage to a variable focus lens 16 so as to align the focal point of the aiming laser light L3 with the specific part of the irradiation target. The drive circuit 11 also applies a drive voltage to an optical scanning section 17 to adjust the emission angle of the aiming laser light L3 so that the aiming laser light L3 irradiates the specific part of the irradiation target.

The infrared camera 222 also captures image data P3 that includes reflected light of the aiming laser light L3. Based on the image data P3, the identification section 32 determines whether or not the aim of the irradiation section 201 is aligned with the specific part of the irradiation target. If the aim of the irradiation section 201 is aligned with the specific part of the irradiation target, the drive circuit control section 33 outputs, to the drive circuit 11, an instruction for switching from a scanning mode to a shooting mode. That is, the drive circuit control section 33 outputs, to the drive circuit 11, an instruction to apply a drive current to the blue LD 12c without changing the focal length of the variable focus lens 16 or the emission angle of the laser light.

With such a configuration, the irradiation device 200, before emitting shooting laser light L2, aligns the aim using aiming laser light L3 which is infrared light. In this way, the visual perception of an insect pest is unlikely to react to infrared laser light which is outside a luminosity wavelength region. That is, in the process of aligning the aim, an insect pest is less likely to notice infrared laser light than in the case of visible light. This improves the probability of shooting the insect pest accordingly. It should be noted that, even without using a highly accurate distance measurement sensor such as LiDAR, it is possible to accurately irradiate a specific part of an irradiation target with shooting laser light L2. That is, with the simplified structure of the irradiation section 201, it is possible to use a relatively inexpensive system to achieve the irradiation of a specific part of an irradiation target.

The irradiation device 200 can be configured to include, instead of the stereo color cameras 221 and the infrared camera 222, a light reception section that detects reflected light of infrared light which has been emitted by the infrared LD 12d and optical scanning section 17 and to use infrared LiDAR. In this case, scanning infrared light causes information (three-dimensional image) pertaining to the shape, size, distance, and angle of an insect pest to be obtained. This makes it possible to omit the stereo color cameras 221 and the infrared camera 222 from the irradiation device 200, and achieve a compact and low-cost system that targets a specific part of an insect pest and shoot the insect without being noticed.

### Example

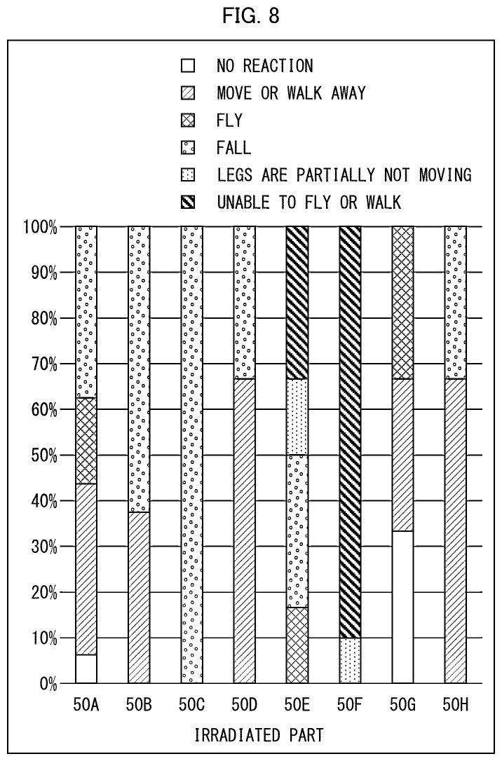

FIG. 8 is a view showing the reactions of insects when each part (wings 50A, antennae 50B, head 50C, back 50D, face 50E, thorax 50F, abdomen 50G, and ovipositor 50H) of the insects was irradiated with laser light whose intensity was modulated in the form of pulses. In the example shown in FIG. 8, Spodoptera litura was used as an irradiation target. Spodoptera litura that was being still (not constrained) in a plastic case was irradiated with laser light using a laser device (DDL-W450-C200-P20-D; manufactured by Shimadzu Corporation), and the reaction of Spodoptera litura was studied. The distance from the objective lens (AC080-016-A-ML; manufactured by Thorlabs, Inc.) to Spodoptera litura was approximately 3 m. Also used was laser light that has a beam spot diameter of 6 mm, a wavelength of 448 nm (that is, blue laser light), an output of 17.8 W, and a pulse length of 100 ms.

It is inferred that the state in which the shot insect was “unable to fly or walk” was the state in which the most effective damage was made to the insect. This is because, in this state, the insect was unable to move. It is inferred that the state in which the shot insect was “partially not moving the legs” was the state in which the next most effective damage was made.

As illustrated in FIG. 8, the thorax 50F was a part where the most effective damage was made to Spodoptera litura. This is presumably because the thoracic nervous system (such as ganglia or peripheral nerves) (or the muscles of the thoracic part) of Spodoptera litura was damaged. The face 50E was a part where the next most effective damage was made to Spodoptera litura. This is presumably because the subesophageal nervous system was damaged. There were also cases where shooting the face 50E caused the proboscis to remain extended. It is inferred that when the proboscis is damaged, Spodoptera litura is unable to exhibit a foraging behavior. Although not exhibited as an immediate reaction, irradiating the ovipositor 50H with laser light causes damage to the reproductive organ of Spodoptera litura, and therefore presumably makes it possible to reduce the breeding of Spodoptera litura.

The ganglia, among these important nervous systems, are located over the head part, the thoracic part, and the abdominal part of an insect, toward the leg side rather than the back side. Therefore, it was generally more effective to shoot the leg side rather than the back side. However, shooting the abdomen 50G resulted in an immediate effect less in comparison with shooting the thorax 50F.

The effect of shooting these specific parts with laser light was confirmed not only in Spodoptera litura but also in Oxya, Atractomorpha lata, and Heteroptera in a similar manner. In particular, irradiating the thorax (base of the legs) with laser light exhibited great effect of suppressing the behaviors.

Suppressing behaviors of an insect pest, such as moving, foraging, or reproducing, makes it possible to effectively suppress activities (such as breeding activity) of the insect pest.

With such a configuration, it is possible to use a physical method to reduce insect pests, and therefore increases a crop production volume and promotes improvements in agricultural productivity. This reduces the use of chemical pesticides and bioprocessing such as genetic modification, and therefore contributes to achievement of the sustainable development goals (SDGs).

### [Software Implementation Example]

A function of the irradiation device 100 (hereinafter referred to as “device”) can be realized by a program for causing a computer to function as the device, the program causing the computer to function as each of the control blocks (particularly each section included in the control section 3) of the device.

In this case, the device includes, as hardware for executing the program, a computer which includes at least one control device (e.g., processor) and at least one storage device (e.g., memory). By the control device and the storage device executing the program, each function described in each of the foregoing embodiments is realized.

The program may be stored in at least one non-transitory, computer-readable storage medium. This storage medium may or may not be included in the above device. In the latter case, the program may be made available to the device via any wired or wireless transmission medium.

Furthermore, some or all of functions of the control blocks can also be realized by a logic circuit. For example, the scope of the present invention also encompasses an integrated circuit in which a logic circuit that functions as the control blocks is provided. In addition, the functions of the control blocks can also be realized by, for example, a quantum computer.

The processes described in the above embodiments can be carried out by artificial intelligence (AI). In this case, AI may be operated in the control device, or may be operated in another device (e.g., an edge computer or a cloud server).

In order to attain the object, an irradiation device in accordance with an aspect of the present invention includes: a detection section that detects an insect which is an irradiation target; an identification section that identifies position information of the irradiation target; and an irradiation section that, based on the position information, irradiates the irradiation target with shooting laser light while targeting a specific part of the irradiation target.

### Recap

An irradiation device in accordance with Aspect 1 of the present invention includes: a detection section that detects an insect which is an irradiation target; an identification section that identifies position information of the irradiation target; and an irradiation section that, based on the position information, irradiates the irradiation target with shooting laser light while targeting a specific part of the irradiation target.

The irradiation device in accordance with Aspect 2 of the present invention can be configured so that, in Aspect 1, the specific part is at least one selected from the group consisting of a part on a side on which legs at a thoracic part of the insect is positioned and a part on a side on which a mouth at a head part of the insect is positioned. The irradiation device in accordance with Aspect 3 of the present invention can be configured so that, in Aspect 1, the specific part includes a part at which a reproductive organ of the insect is positioned.

The irradiation device in accordance with Aspect 4 of the present invention can be configured so that, in any of Aspects 1 through 3, the irradiation section irradiates the irradiation target with the shooting laser light that has a beam diameter which is smaller, at a position of the irradiation target, than an entire length of the irradiation target.

The irradiation device in accordance with Aspect 5 of the present invention can be configured so that, in any of Aspects 1 through 4, the irradiation section irradiates a predetermined range with scanning laser light; and the irradiation device includes a light reception section that receives reflected light of the scanning laser light and generates a light reception signal which allows the detection section to detect the irradiation target.

The irradiation device in accordance with Aspect 6 of the present invention can be configured so as to, in any of Aspects 1 through 4, include a first image capturing section that captures image data which allows the detection section to recognize the irradiation target.

The irradiation device in accordance with Aspect 7 of the present invention can be configured so that, in any of Aspects 1 through 6, before the irradiation section emits the shooting laser light, the irradiation section irradiates the irradiation target with aiming laser light which is for aligning an aim with the irradiation target; and the irradiation device includes a second image capturing section that captures image data which includes reflected light of the aiming laser light.

The irradiation device in accordance with Aspect 8 of the present invention can be configured so that, in any of Aspects 1 through 7, the irradiation section includes a variable focus lens that changes a focal length of the shooting laser light.

An irradiation method in accordance with Aspect 9 of the present invention includes the steps of: detecting an insect which is an irradiation target; identifying position information of the irradiation target; and irradiating, based on the position information, the irradiation target with shooting laser light while targeting a specific part of the irradiation target.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 201 Irradiation section
2 Light reception section
3 Control section
16 Variable focus lens
31 Detection section
32 Identification section
50 Irradiation target
50E Face (part on the side on which the mouth at the head part of the insect is positioned)
50F Thorax (part on the side on which the legs at the thoracic part of the insect are positioned)
50H Ovipositor (part at which the reproductive organ of the insect is positioned)
100, 200 Irradiation device
221 Stereo color camera (first image capturing section)
222 Infrared camera (second image capturing section)
L1 Scanning laser light
L2 Shooting laser light
L3 Aiming laser light
P1, P3 Image data
R1 Reflected light

1. An irradiation device comprising:
a detection section that detects an insect which is an irradiation target;
an identification section that identifies position information of a specific part of the irradiation target based on a three-dimensional image which has been obtained by the detection section and which makes it possible to recognize the irradiation target; and
an irradiation section that, based on the position information, irradiates the irradiation target with shooting laser light having a beam diameter of 1 mm to 10 mm, while the specific part of the irradiation target is targeted.

2. The irradiation device according to claim 1, wherein the specific part is at least one selected from the group consisting of a part on a side on which legs at a thoracic part of the insect is positioned and a part on a side on which a mouth at a head part of the insect is positioned.

3. The irradiation device according to claim 1, wherein the specific part is a part at which a reproductive organ of the insect is positioned.

4. The irradiation device according to claim 1, wherein the irradiation section irradiates the irradiation target with the shooting laser light that has a beam diameter which is smaller, at a position of the irradiation target, than an entire length of the irradiation target.

5. The irradiation device according to claim 1, wherein:
the irradiation section irradiates a predetermined range with scanning laser light; and
the irradiation device comprises a light reception section that receives reflected light of the scanning laser light and generates a light reception signal which allows the detection section to detect the irradiation target.

6. (canceled)

7. (canceled)

8. (canceled)

9. (canceled)

10. An irradiation device comprising:
a detection section that detects an insect which is an irradiation target;
an identification section that identifies position information of the irradiation target;
an irradiation section that, based on the position information, irradiates the irradiation target with shooting laser light having a beam diameter of 1 mm to 10 mm, while a specific part of the irradiation target is targeted; and
a first image capturing section that obtains first image data which allows the detection section to recognize the irradiation target, wherein:
before the irradiation section emits the shooting laser light, the irradiation section irradiates the irradiation target with aiming laser light which is for aligning an aim with the irradiation target, and
the irradiation device further comprises a second image capturing section that captures an image of reflected light of the aiming laser light so as to obtain second image data which allows the identification section to determine whether or not the aim of the irradiation section is aligned with the specific part.

11. The irradiation device according to claim 10, wherein the aiming laser is infrared laser light.
